(19) United States
(12) Patent Application Publication
(10) Pub. No.: US 2026/0200726 A1
(43) Pub. Date: Jul. 16, 2026

(54) CONTINUOUS REACTORS OF FORMATE-BICARBONATE CYCLE FOR HYDROGEN STORAGE AND RELEASE

(71) Applicant: HYDRO X LTD, Jerusalem (IL)

(72) Inventors: Asa ZIV, Givat-Shmuel (IL); Eviatar GOLAN, Mazkeret-Batya (IL); Ariel GIVANT, Jerusalem (IL); Eitan ELFASSY, Rehovot (IL); Shmuel GONEN, Jerusalem (IL); Guy NESHER, Efrat (IL); Daniel TZABARI, Talmon (IL)

(21) Appl. No.: 19/129,934

(22) PCT Filed: Nov. 16, 2023
(86) PCT No.: PCT/IL2023/051189

§ 371 Date: May 14, 2025

Related U.S. Application Data
(60) Provisional application No. 63/426,461, filed on Nov. 18, 2022.
(60) Provisional application No. 63/498,128, filed on Apr. 25, 2023.

(51) Int. Cl. C01B 3/0015; B01J 8/00; B01J 8/08; B01J 8/10; B01J 23/96; B01J 38/12; B01J 38/60; C01B 3/22

(52) U.S. Cl. CPC C01B 3/0015; B01J 8/0045; B01J 8/006; B01J 8/007; B01J 8/085; B01J 8/10; B01J 23/96; B01J 38/12; B01J 38/60; C01B 3/22; B01J 2208/00752; B01J 2208/00867; C01B 2203/0277; C01B 2203/066; C01B 2203/107; C01B 2203/169

(57) ABSTRACT

A continuous process for releasing hydrogen using the dehydrogenation reaction of the formate-bicarbonate cycle, comprising continuously feeding an aqueous solution of formate and a heterogeneous catalyst to a dehydrogenation reactor to form bicarbonate and hydrogen, directing the hydrogen for use as a fuel hydrogen, removing a flowable effluent continuously from the dehydrogenation reactor at a rate equal to the feeding rate, and directing the effluent into a product tank, discharging a material from the product tank and separating the catalyst from the material, washing and refreshing the catalyst and returning the refreshed catalyst to the dehydrogenation reactor, wherein bicarbonate is collected in a solid form from the product tank.

### FIELD OF THE INVENTION

The invention relates to a method for storage of hydrogen in a chemical carrier, in a safe and transportable form, and the release of hydrogen on demand, based on the bicarbonate-formate cyclic system.

### BACKGROUND

The bicarbonate-formate cycle consists of two reversible chemical reactions that are related by an equilibrium constant. On the one side of the chemical equilibrium a hydrogenation reaction of an alkali metal salt of bicarbonate is present, while on the other side of the chemical reaction an alkali metal salt of formate and a water molecule are present:

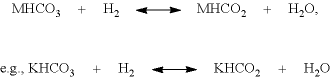

The reaction from left to right is the hydrogenation of bicarbonate to give the corresponding formate, whereby hydrogen is stored, i.e., the resultant formate salt is a hydrogen carrier. On demand, the reverse reaction (dehydrogenation) is carried out to release hydrogen: the formate is decomposed to produce bicarbonate and hydrogen which can be used for any desired purpose, e.g., as a fuel material.

The hydrogenation and dehydrogenation reactions are both advanced with the aid of a catalyst, which may be the same or different for the two reactions. For a reversible hydrogen storage cycle to gain significant commercial acceptance, the catalyst of choice must be highly active and easily separable and regenerable.

The higher the concentration of the aqueous formate solution, the greater the amount hydrogen that can be stored by the solution. However, one of the main challenges of the system arises from the difference in the water solubility of the formate and bicarbonate salts. The bicarbonate is significantly less soluble in water than the formate. Therefore, during the dehydrogenation process of a concentrated formate solution, a solid precipitate of bicarbonate is formed. When a heterogeneous catalyst is used, e.g., particles of palladium supported on carbon, then a slurry consisting of solid bicarbonate and catalyst particles is formed, interfering with the separation and regeneration of the catalyst.

A solution to such problem was shown in U.S. Pat. Nos. 10,618,807, #10,207,921 and #10,688,474. A reversible hydrogen storage cycle based on the use of a concentrated solution of potassium formate is demonstrated in these patents, where it has been shown that with the aid of palladium on carbon catalyst, a concentrated potassium formate solution decomposes to generate hydrogen and a slurry consisting of solid bicarbonate and catalyst particles. The same catalyst is also effective in the reverse reaction, i.e., the conversion of potassium bicarbonate slurry to an aqueous solution of potassium formate. The catalyst was successfully regenerated on treating the slurry with a stream of air, i.e., without catalyst separation. Therefore, the use of the formate-bicarbonate cycle with occasional catalyst regeneration is of high interest for hydrogen and energy storage.

U.S. Pat. No. 10,944,119 shows a different approach, based on homogeneous catalysis. That is, the dehydrogenation reaction of aqueous MHCO₂ is catalyzed effectively with the aid of a metal complex, such as ruthenium-containing complex, dissolved in a suitable organic solvent. Hydrogen gas is generated while the bicarbonate is progressively formed in the aqueous phase, with the organic solvent remaining separable from the bicarbonate throughout the reaction. When the catalyst is a homogenous catalyst, like in U.S. Pat. No. 10,944,119, the different solubilities of the bicarbonate/formate salts in water does not create a problem because the solubilized catalyst remains in the organic phase, which enables the separability of the catalyst owing to the immiscibility of the organic solvent in water. However, the introduction of an organic solvent into the process adds other issues of separation and quality control to the system.

Alternatively, the reversible hydrogen storage cycle based on the KHCO₃+H₂↔KHCO₂+H₂O reactions can also operate with the aid of two different catalysts. According to this process design, a solid catalyst, such as palladium supported on carbon, is employed for catalyzing the hydrogenation of a bicarbonate slurry to form a concentrated aqueous solution of potassium formate. To generate hydrogen, the concentrated formate solution undergoes dehydrogenation as described above, in the presence of a catalyst system consisting of a metal-containing complex dissolved in a suitable organic solvent.

As mentioned above, U.S. Pat. Nos. 10,618,807, #10,207,921 and #10,688,474 involve the use of aqueous streams devoid of organic solvents and offer a method to refresh the catalyst inside the reactor during the process by draining the reactor tank after every batch cycle, and treating the catalyst in air inside the reactor, while in admixture with the bicarbonate. Such an approach is acceptable but has several unattended issues:
a. The reactor tank is full with hydrogen and a mix of air with hydrogen is not safe.
b. The process is not continuous and therefore the hydrogen stream supplied by the system is not stable.
c. The scale up of batch systems is much limited than that of continuous systems and the overall production energy balance tends to be less attractive in batch systems, a fact that is of high importance for an energy storage system.

Therefore, there exists a need for an improved aqueous system that can be fully continuous and overcome the specific characteristics of the formate-bicarbonate cycle system and still be an attractive system in terms of energy balance.

### SUMMARY OF THE INVENTION

We have found that the bicarbonate precipitate, that is progressively formed upon decomposition of the formate in the aqueous solution, consists of surprisingly large particles, e.g., with average diameter >200 microns (typically several hundred microns and even more). When suitably small catalyst particles are used to advance the decomposition of the formate, say, with size below 100 microns, e.g., <50 microns, for example, <40 microns, e.g., <10 microns, then the catalyst is separable from the solid bicarbonate by techniques based on size exclusion. Furthermore, it has been observed that spontaneous separation occurs during decomposition of the formate and concomitant hydrogen release. The densities of the formate solution, the potassium bicarbonate and the catalyst are ~1.4 g/cm³, ~2.2 g/cm³, and 0.3 g/cm³, respectively. Therefore, potassium bicarbonate crystals that precipitate in the solution move downward and settle at the bottom of the reaction vessel, while the fine catalyst particles are moving upward. Furthermore, hydrogen bubbles produced by the dehydrogenation of the formate over the catalyst (e.g., Pd/C) facilitate the upward movement of the catalyst particles. A photograph of a reaction vessel appended in FIG. 9, captured towards the end of a typical formate decomposition reaction advanced by Pd/C catalyst, shows that the catalyst (black particles) produces hydrogen gas in the upper part of the solution (bubbles can be seen), while the potassium bicarbonate (in white solid form) has already settled at the bottom of the flask. The bulk solution consists of water and unreacted solubilized formate.

The invention is therefore primarily directed to a continuous process for releasing hydrogen using the dehydrogenation reaction of the formate-bicarbonate cycle, comprising continuously feeding an aqueous solution of formate and a heterogeneous catalyst to a dehydrogenation reactor to form bicarbonate and hydrogen, directing the hydrogen for use as a fuel hydrogen, removing a flowable effluent continuously from the dehydrogenation reactor, e.g., at a rate equal to the feeding rate, and directing the effluent into a product tank, discharging a material from the product tank and separating the catalyst from the material, washing and refreshing the catalyst and returning the refreshed catalyst to the dehydrogenation reactor, wherein bicarbonate is collected in a solid form from the product tank.

The aqueous formate solution undergoing dehydrogenation is preferably potassium formate at concentration of not less than 7M, e.g., >8M, e.g., >10M, but other options are tabulated in Table 1 below. Experimental work reported below indicates that addition of an alkaline agent to adjust the pH to 9-12 (10-11) e.g., alkali hydroxide (e.g., KOH) or even better alkali carbonate (e.g., K₂CO₃) suppresses evolution of carbon dioxide and reduces foaming during the dehydrogenation reaction, for example, addition of K₂CO₃ at concentration above 0.5M, e.g., 0.5-1.0M.

The catalyst consists of a catalytically-active transition metal on solid support particles, wherein the diameter of the solid support particles is less than 100 μm, e.g., <50 microns, for example, <40 microns, from 3 to 40 microns. For example, the catalyst comprises Pd or Pt on a solid support selected from activated carbon, graphite, SiO₂, TiO₂, or metallic substrate such as Al, Cu, Nickel, stainless steel, or any other metal, optionally with carbon coating.

The preferred heterogeneous catalyst is Pd on carbon (e.g., activated carbon) wherein the diameter of the carbon particles is from 4 to 40 μm. Suitable carbon particles are either available commercially or can be prepared by grinding.

A suitable sieve with appropriate pore size (e.g., from 40 to 150 micron, e.g., 40 to 80 micron) is mounted in the product tank, partitioning the product tank into a lower section and an upper section, wherein the flowable effluent from the dehydrogenation reactor is fed to the lower section of the product tank, such that bicarbonate particles settle at the bottom of the product tank, and catalyst particles float and accumulate at the upper section of the product tank. The material is discharged from the upper section of the product tank, consisting of formate solution with catalyst particles, and is fed to a separation and washing unit, in which the catalyst particles are separated from the formate solution and washed.

The separation and washing are preferably performed off-line, i.e., in a batch mode. The separation and washing unit alternates between a separation mode, during which said unit is supplied by the effluent from the product tank, to separate the catalyst particles from the aqueous phase, and a washing mode, during which said unit is supplied by the washing solution, to wash the catalyst particles.

The separated catalyst particles are washed by a washing solution selected from the group consisting of water, an aqueous acidic solution, and an aqueous oxidizer (e.g., hydrogen peroxide) solution. Washing with an acidic aqueous stream, consisting of a mineral acid (e.g., nitric acid, hydrochloric acid, phosphoric acid, sulphonic acid) or organic acid (e.g., citric acid, benzoic acid, salicylic acid, acetic acid), e.g., at a temperature above 30° C., has shown to be useful, especially treating the particles with nitric acid, e.g., 5-15%, 7-13%, ~10% by weight HNO₃ solution.

Next, the washed catalyst particles are refreshed by drying and oxidation, performed sequentially or simultaneously. Preferably, the washed catalyst particles are dried and oxidized simultaneously by the action of an air stream to obtain the refreshed catalyst, which is returned to the dehydrogenation reaction.

The separability of the catalyst particles from the bicarbonate particles, that is based on the difference in the particle size, could also be exploited for running the hydrogenation reaction (i.e., the reaction of bicarbonate slurry with hydrogen under heterogeneous catalysis) in a continuous mode, with in-line catalyst separation (i.e., after the completion of the reaction and before transferring the formate product to the product tank). Thus, the invention provides a continuous process for storing hydrogen using the hydrogenation reaction of the formate-bicarbonate cycle, comprising continuously feeding an aqueous slurry of bicarbonate, hydrogen and a heterogeneous catalyst to a hydrogenation reactor having a sieve mounted in proximity to the reactor outlet to prevent bicarbonate particles from leaving the reactor, removing an effluent continuously from the outlet of the hydrogenation reactor into a separator, e.g., at a rate equal to the feeding rate, wherein the effluent is in a form of a suspension comprising dissolved formate and suspended catalyst particles and perhaps residual solubilized bicarbonate, separating the effluent into an aqueous formate and a solid catalyst, wherein the separation is downstream to the hydrogenation reactor and upstream to a product tank, directing the aqueous formate to the product tank, washing and refreshing the catalyst in a washing unit, and returning the refreshed catalyst to the hydrogenation reactor continuously. The washing and refreshing of the catalyst particles are achieved with the aid of the same washing solutions and air stream as described for the dehydrogenation reaction.

The hydrogenation and dehydrogenation reactions may be performed separately, at different locations or may be run to afford a full cycle for energy storage and release. That is, the invention provides a process comprising the continuous hydrogenation reaction, producing a concentrated aqueous formate solution from bicarbonate and hydrogen in the presence of heterogeneous catalyst, and the continuous dehydrogenation reaction, decomposing said concentrated aqueous formate to bicarbonate slurry and hydrogen gas in the presence of the heterogeneous catalyst, wherein the reactions are performed in a cyclic manner with catalyst separation and regeneration.

More specifically, the invention provides a process for storing and releasing hydrogen using the formate-bicarbonate cycle, wherein the process comprises:
A) hydrogenation reaction producing an aqueous formate solution from bicarbonate and hydrogen in the presence of heterogeneous catalyst as described above, and
B) dehydrogenation reaction decomposing the aqueous formate solution of A) to form bicarbonate and hydrogen gas in the presence of a heterogeneous catalyst as described above, and supplying the bicarbonate to the hydrogenation reaction of step A),
wherein the reactions are performed in a cyclic manner with catalyst separation and refreshment.

The invention further provides an apparatus for continuous production of hydrogen by dehydrogenation of aqueous formate solution, comprising:
a first storage tank (71), in which an aqueous formate solution is held, connected by a feed line to a dehydrogenation reactor (72), with a heat exchanger optionally positioned along said feed line;
a catalyst feeder (83/83) to supply dry granular or powdered material to the dehydrogenation reactor, e.g., a screw conveyor hooper;
the dehydrogenation reactor (72), having a first outlet equipped with a gas discharge line (77) to withdraw hydrogen gas evolving in the reactor and deliver the hydrogen to a pressure cylinder or a fuel cell, and a second outlet equipped with a liquid discharge line to direct flowable effluent from the dehydrogenation reactor to a product tank (73);
the product tank (73), which is partitioned by a sieve into to a lower section (73A) and an upper section (73B), with the liquid discharge line (87) from the dehydrogenation reactor entering the lower section of said product tank (73A),
a separation and washing unit (74), which is supplied alternately by appropriate arrangement of valves either from the product tank (73), wherein the upper section of the product tank (73B) is connected by a discharge line (88) to the separation and washing unit (74), or from a washing solution feed line (75), such that the separation and washing unit alternates between a separation mode, during which it is supplied by an effluent pumped through the discharge line from the product tank, and a washing mode, during which it is supplied by the washing solution;
wherein the separation and washing unit is provided with a return line (86) to direct liquid phase consisting of formate solution collected during separation to the dehydrogenation reactor, and with a catalyst recycle line (89) connected to a drying and oxidation unit (79), to supply refreshed catalyst the catalyst feeder (82/83) or spent catalyst to a storage tank (81).

The drying and oxidation unit (79) is fed by an air line, i.e., air streams are used to dry, oxidize, and push the catalyst particles to the catalyst feeder (82/83). The dehydrogenation apparatus further comprises a nitrogen line.

The invention further provides an apparatus for continuous storage of hydrogen by reacting aqueous bicarbonate slurry with hydrogen to form formate, comprising:
a first storage tank (41), in which bicarbonate slurry is held, connected by a feed line to a mixing unit (43);
a catalyst feeder (52/58) to supply dry granular or powdered material to the mixing unit (43), e.g., a screw conveyor hooper;
a mixing unit (43), provided with an agitator to produce an aqueous slurry of bicarbonate and catalyst particles and with a discharge line (59) to supply said suspension to a first hydrogenation reaction (44);
a first hydrogenation reactor (44) and optionally a second hydrogenation reactor (45), arranged in series, wherein the discharge line (59) of the mixing unit (43) is connected to an inlet of the first hydrogenation reactor (44) and wherein each hydrogenation reactor has a gas inlet connected to hydrogen feed line (55) to introduce hydrogen gas to each hydrogenation reactor; and wherein the first hydrogenation reactor (44) or the second hydrogenation reactor (45), as appropriate, discharges to a solid/liquid separation unit (46), and wherein the first hydrogenation reactor (44) has a sieve mounted in proximity to the reactor outlet to prevent bicarbonate particles from leaving the reactor;
a product tank (47), connected to the solid/liquid separation unit (46), to receive liquid stream therefrom consisting of aqueous formate solution;
a washing tank (49), connected to the solid/liquid separation unit (46), to receive the solid catalyst particles collected in the solid/liquid separation unit (46); wherein the washing tank is connected by a catalyst recycle line (60) to a drying and oxidation unit (50), to supply refreshed catalyst the catalyst feeder (52/58) or a spent catalyst to a recycle tank (51).

The drying and oxidation unit (50) is fed by air line, i.e., air streams are used to dry, oxidize, and push the catalyst particles to the catalyst feeder (52/53). The hydrogenation apparatus further comprises a nitrogen line.

Thus, the present invention illustrates a new method to store and release hydrogen using a formate-bicarbonate cycle. The system is continuous both for the reaction and the catalyst refreshment process. The advantage of the current approach is that it stabilizes the hydrogen production rate, it is scalable, and it presents a much safer approach since it is does not involve hydrogen-air mixing which can lead to explosion.

This forms the basis for yet another aspect of the invention, which is a method of distributing hydrogen on-demand from a production site to customers, comprising: hydrogenation reaction producing an aqueous formate solution from bicarbonate and hydrogen in the presence of heterogeneous catalyst, wherein the hydrogenation reaction is run in a continuous mode of operation with on-line catalyst refreshment and recycling; transporting the formate, either in an aqueous or dry form, to a hydrogen distribution site; dehydrogenation reaction decomposing an aqueous formate solution to form bicarbonate and hydrogen gas on-demand in the presence of a heterogeneous catalyst wherein the hydrogenation reaction is run in a continuous mode of operation with, e.g., off-line catalyst refreshment and recycling.

The catalyst can be a Pd or Pt based catalysts, but other transition metal catalysts were used and found to be effective, e.g., silver, nickel, ruthenium or molybdenum catalysts, or their combination with platinum or palladium catalyst. The catalyst may be distributed on any substrate and a typical substrate for the catalyst is activated carbon. Other options can be SiO₂, TiO₂, or even a metallic substrate such as Al, Cu or any other metal. In other embodiments of the current invention a carbon fiber of fabric can be used as a substrate for the catalyst, or a polymeric matrix can be used for the same purpose. In other embodiments of the current invention an activated carbon, carbon black or graphene oxide in a reduced or a non-reduced form can be used as a substrate for the catalyst. A preferred form of the catalyst consists of a metal (e.g., Pd) supported on fine particles, e.g., particles with size in the range of 4 to 40 microns e.g., carbon particles (with the carbon types listed above) at catalytic metal concentration of 0.5 to 10% by weight, e.g., 1 to 2% by weight.

Dehydrogenation of the aqueous formate is carried out at a temperature in the range of 30-90 degrees Celsius, in some cases operating at room temperature is also acceptable. The temperature of hydrogenation reaction is preferably in the range of 20-40 degrees Celsius.

The hydrogenation reaction is conducted under pressure, i.e., above atmospheric pressure. The typical values of the hydrogen pressure are 10-20 atmospheres; in other cases the hydrogen pressure is from 20-50 atmospheres or to 50-200 atmospheres.

Salts of formate and bicarbonate, other than potassium salts, can be used (e.g., cesium and ammonium salts). Table 1 shows the change in energy concentration in the formate-bicarbonate cycle due to changing the counter ion in the process. The solubility of the corresponding formate and bicarbonate salts varies and the concentration in which a separation between the salts is possible also varies.

TABLE 1
Other formate salts that can be used for the energy cycle

| | MW | # of water | Toal | % H₂ in |
|---|---|---|---|---|
| Formate | (g/mol) | molecules | weight (g/mol) | the product |
| LiHCO₂ | 51.96 | 1 | 69.96 | 2.86% |
| NaHCO₂ | 68.01 | 1 | 86.01 | 2.33% |
| KHCO₂ | 84.12 | 1 | 102.12 | 1.96% |
| RbHCO₂ | 130.5 | 1 | 148.5 | 1.35% |
| Be(HCO₂)₂ | 99.05 | 2 | 135.05 | 2.96% |
| Mg(HCO₂)₂ | 114.34 | 2 | 150.34 | 2.66% |
| Ca(HCO₂)₂ | 130.113 | 2 | 166.113 | 2.41% |
| Sr(HCO₂)₂ | 177.65 | 2 | 213.65 | 1.87% |
| B(HCO₂)₃ | 145.87 | 3 | 199.87 | 3.00% |
| Al(HCO₂)₃ | 162.033 | 3 | 216.033 | 2.78% |
| Ga(HCO₂)₃ | 204.78 | 3 | 258.78 | 2.32% |
| In(HCO₂)₃ | 249.87 | 3 | 303.87 | 1.97% |

In some embodiments of the current invention, the hydrogenation process is carried out at using a slurry with bicarbonate content corresponding to 10-14 moles in liter; according to other embodiment of the current invention the amount of bicarbonate is 3-10 moles and in others a very high amount of bicarbonate will be used above (>14M) and even water-free solid bicarbonate can be used for the process initialization upon addition of water on site.

In some embodiments of the current invention, the hydrogenation reaction separation process is carried out in-line just after the completion of the reaction and before transferring the products of the reaction to the product tank. In other embodiments of the current invention the catalyst will be separated from the formate offline by additional process on the product tank (similar to the process that is discussed in respect of the dehydrogenation reaction process).

In some embodiments of the current invention, the dehydrogenation process is done at a high molar concentration. Typically, at 10-14M of formate concentration, in other embodiments of the present invention the formate concentration is 5-10M and in others a very high concentration of formate will be used, above 14M and even solid formate can be used for the process initialization upon addition of water on site.

In some embodiments of the current invention, the dehydrogenation process is done at 50-90 degrees Celsius in other embodiments of the current invention, the reaction temperature will be lower, from room temperature to 50 degrees Celsius.

In some embodiments of the current invention, the hydrogenation process starts with a reactant tank filled with potassium bicarbonate salt in a slurry form. The slurry flows through a mixing unit to the reactors to produce formate. After the reaction the product and the catalyst are separated, the liquid is transferred the potassium formate tank and the catalyst is washed, refreshed and returned to the reaction by the mixing unit.

In some embodiments of the current invention, at the hydrogenation process a pump or another mixing unit is added to the reactant tank to prevent the slurry from clogging the pipes. In other embodiments of the current invention the slurry will be lifted by a screw to distribute the solids in the solution inside the reactant tank for the same purpose.

In some embodiments of the current invention, the slurry at the hydrogenation process is mixed with a catalyst in the way to the first reactor in a mixing tank. The mixing tank can be replaced by other methods to mix solids into liquids for instance a vortex pipes or a screw.

In some embodiments of the current invention, the catalyst amount inside the reactors is constant. In other embodiments of the current invention the catalyst amount is adjusted to control a constant product stream out of the reactor in both hydrogenation and dehydrogenation processes.

In some embodiments of the current invention, the ratio between the catalyst inside the reactor and the catalyst in the refreshment cycle is constant. A typical values is from 1:1 to 1:2 for catalyst inside:outside of the reactor. However, a better and faster refreshment cycles can reduce the ratio to 1:0.1 to 1:0.3, or to 1:0.3 to 1:1 and in turn to reduce the overall cost of the system.

In some embodiments of the current invention, in the hydrogenation process the slurry is pushed against pressure into the first reactor. The pressure is of hydrogen gas that is a reactant to the hydrogenation reaction and it needs to be at a high pressure to allow good conversion, preventing the spontaneous reverse dehydrogenation reaction of the formate back to bicarbonate. A typical pressure is 10 bar, a 10-20 bar or 20-50 bars pressure can be used and even 50-200 bars will be used in some embodiments of the current invention.

In some embodiments of the current invention, a heat exchanger is used maintain the same temperature in the reaction tank. A typical temperature for the hydrogenation reaction is 25-35 degrees Celsius. In other embodiments of the current invention lower temperatures will be used to reduce the reverse reaction, in yet other embodiments of the present invention 35-70 degrees Celsius will be used to increase the rate of the reaction.

In some embodiments of the current invention, the reaction tank is monitored with the aid of several sensors. The most important parameters that need to be monitored are the temperature at the reactor, the pressure and the amount of material inside the reactor. For example, the amount of the material inside the tank is monitored by a wet point sensor or by a height sensor.

In some embodiments of the present invention, the feed stream to the hydrogenation reactor contains solid catalyst and a bicarbonate slurry. To allow the solid bicarbonate fraction to be consumed by the reaction and only the liquid part to continue to the next reactors, a sieve (i.e., a size filter) is placed close to the exit point of the reactor, preventing from the solid bicarbonate to leave the first reactor, and allowing transfer of the catalyst to the next reactors.

In some embodiments of the current invention, additional reactors will be used after the first reactor. In some embodiments of the current invention, the second or more reactors could be a CSTR reactor. However, since the reaction is only in the liquid phase another reactor options are possible for that part of the process. Examples will be a PFR reactor or a static mixer or an auger reactor at low temperature.

In some embodiments of the current invention, the pressure at the second or more reactors should be higher than the pressure in the first reactor to increase the conversion even higher and no filtration is needed.

In some embodiments of the current invention, the output stream of the reactors at the hydrogenation process is fed into a liquid solid separator. In other embodiments of the current invention, it could be fed directly to the product tank.

In some embodiments of the current invention, the separator is in-line with the process and therefore it continuously transferring the product as an output stream to the product tank. A filter is collecting the solid part of the catalyst and every time segment it pushes the catalyst cake to a washing tank with the aid of an inert gas stream.

In some embodiments of the current invention, the separator will be a CONTIBAC filter from DrM or similar separator that can separate continuously and efficiently the formate liquid and the catalyst.

In some embodiments of the current invention, the product tank is a vessel at a similar size as the reactant tank and the product will be used as is to feed a consumer. In other embodiments of the current invention, the product will be dried and shipped as a solid to the consumer.

The catalyst that exits the separator is pushed to a washing tank. In some embodiments of the current invention, the refreshment cycle is done by washing the catalyst from traces of format and bicarbonate to prevent hydrogen production during the refreshment cycle.

In some embodiments of the current invention, purified water will be used to wash the catalyst. The water can be reused for next washing cycle or flow to drain.

In some embodiments of the current invention, additional washes will be done to the catalyst by acids or any additional wash by liquid material.

In some embodiments of the current invention, the water or the acids wash is done at room temperature. In some embodiments of the current invention, higher temperatures will be used. A typical wash temperature is 30-50 degrees Celsius, other treatments could be done at 50-80 degrees Celsius and higher temperatures can be used as well.

In some embodiments of the current invention, the catalyst will be transferred from the washing tank as a wet cake to a dryer.

In some embodiments of the current invention, the dryer can be a conveyor with heated elements or IR lamps. In other embodiments of the current invention, the drier will be a screw with an air stream at any speed and temperature. In yet another embodiments of the current invention, other oxidizing agent such as chemical vapor or UV heating or charging will be used for reactivation of the catalyst.

In yet another embodiments of the current invention, other oxidizing agent such as plasma treatment or ozone stream will be used for reactivation of the catalyst.

In some embodiments of the current invention, the catalyst will be promoted to a hooper and feed back to the mixing tank by a feeding screw. In other embodiments of the current invention, the catalyst is pushed by a pump.

In some embodiments of the current invention, the catalyst activity will be too low and a full recycling of the catalyst will be needed. At that point, the used catalyst will be fed to the recycle tank and a new catalyst will be added directly to the hooper.

In some embodiments of the current invention, the reactant tank in the dehydrogenation process is the potassium formate salt that is fed directly to the reactor and is mixed inside it with a new or refreshed catalyst. After the reaction the product and the catalyst flow to a product tank and the product is separated off-line from the catalyst by a continuous flow of products that leave the product tank and flows to a separator. The liquid returns to the product tank from the separator, while the catalyst is washed, refreshed and return directly to the reactor by the mixing unit.

In some embodiments of the present invention, the separator is in-line and the catalyst is removed from the product stream before entering the product tank.

In some embodiments of the present invention, the dehydrogenation process starts at a high concentration potassium formate. Typically, >7M, e.g., from 7-10M, concentration and in other cases 11-15M of salt concentration. However, this concentration is still below the solubility limit and therefore the formate is completely solubilized.

In some embodiments of the present invention, the formate is fed as a solid and premixed with water before it is fed to the reactor.

In yet another embodiment of the present invention, the formate concentration is above the 15.7M where some or most of the salt in the tank is in solid state and a mechanism that prevents clogging is added.

In some embodiments of the current invention, the catalyst is mixed with the formate at the entrance to the reactor and the doses of refreshed catalyst and formate solution are controlled to maintain the same catalyst concentration and conditions during the reaction.

In some embodiments of the current invention, the feeding of the catalyst is done from a close unit where a flow of inert gas will replace air to maintain a safe process flow.

In some embodiments of the current invention, the catalyst ratio between the catalyst inside the reactor and the catalyst in the refreshment cycle will be constant. A typical values is 1:1 to 1:2 for catalyst inside:outside of the reactor. However, a better and faster refreshment cycles can reduce the ratio to 1:0.1 to 1:0.3, or to 1:0.3 to 1:1 and in turn to reduce the overall cost of the system.

In some embodiments of the current invention, a heat exchanger will control the temperature of the reaction between the catalyst and the formate. A typical temperature will be 50-70 degrees Celsius or 70-90 degrees Celsius. In other embodiments of the current invention lower temperatures will be used.

In some embodiments of the current invention, the dehydrogenation tank will be monitored by several sensors. The most important parameters that need to be monitored are the temperature at the reactor, the pressure and the amount of material inside the reactor.

In some embodiments of the current invention, the dehydrogenation reactor can be a CSTR reactor for a good mixing of the materials. However, a static mixer or a low temperature auger reactor with a screw can also be a good choice because the heating can be more efficient at that kind or reactors. In those reactors, it is also possible to increase the temperature with the propagation inside the reaction, a significant advantage that can increase the reaction conversion. As the residence time and the reaction temperature are controlled an optimum conversion can be achieved.

In some embodiments of the current invention, an additional stream may be added to the dehydrogenation reactor to extract a solid bicarbonate that is formed and sediment inside the reactor.

In some embodiments of the present invention, a return stream from the separator will be added to compensate for the extract amount or to increase the conversion.

In some embodiments of the present invention, a hydrogen gas stream will be used by the consumer.

In some embodiments of the present invention, the separator is not in-line with the process and therefore it can work in a batch cycles, separating the catalyst from the formate solution and washing the catalyst alternately. During the separation cycle the formate can flow back to the product tank directly, or better, to the reactor for a second pass to increase the conversion.

In some embodiments of the present invention, solid catalyst is collected on the separator filter periodically the catalyst is pushed with the aid of an inert gas stream (to prevent explosion) to the dryer unit.

In some embodiments of the present invention, the separator for the dehydrogenation process will be a CONTIBAC filter from DrM or similar separator that can separate continuously and efficiently the formate liquid and the catalyst.

In some embodiments of the current invention, the product tank is a vessel at a similar size as the reactant tank and the product will be used as is to feed a consumer. In other embodiments of the current invention, the product will be dried and shipped as a solid to the consumer.

In some embodiments of the present invention, catalyst that leaves the separator is pushed to a washing tank.

In some embodiments of the present invention, the refreshment cycle will be done by washing the catalyst from traces of formate and bicarbonate to prevent hydrogen production during the refreshment cycle.

In some embodiments of the current invention, purified water will be used to wash the catalyst. The water can be reused for next washing cycle or flow to drain.

In some embodiments of the current invention, additional washes will be done to the catalyst by acids or any additional wash by liquid material.

In some embodiments of the current invention, the water or the acids wash will be done in room temperature. In some embodiments of the current invention, higher temperatures will be used. A typical wash temperature is 30-50 degrees Celsius, other treatments could be done at 50-80 degrees Celsius and higher temperatures can be used as well.

In some embodiments of the current invention, the catalyst will be transferred from the washing tank as a wet cake to a dryer.

In some embodiments of the current invention, the dryer can be a conveyor with heated elements or IR lamps. In other embodiments of the current invention, the drier will be a screw with an air stream at any speed and temperature. In other embodiments of the present invention, other oxidizing means such as chemical vapor or UV heating or charging will be used for reactivation of the catalyst.

In some embodiments of the present invention, the catalyst will be promoted to a hooper and feed back to the mixing tank by a feeding screw. In other embodiments of the current invention, the catalyst will be pushed by a pump.

In some embodiments of the present invention, the catalyst activity will be too low and a full recycling of the catalyst will be needed. At that point, the used catalyst will be fed to the recycle tank and a new catalyst will be added directly to the hooper.

### BRIEF DESCRIPTION OF THE DRAWINGS

The present invention is illustrated by way of example, and not limitation, in the figures of the accompanying drawings, in which:

FIG. 1 illustrates, in a conceptual manner, the formate-bicarbonate reaction cycle for energy and hydrogen storage.

FIG. 2 illustrates schematically the concept of a continuous hydrogenation reactor.

FIG. 3 illustrates schematically the concept of a continuous dehydrogenation reactor.

FIGS. 4a and 4b illustrate in two levels a block diagram of a continuous hydrogenation reactor.

FIGS. 5a and 5b illustrate in two levels a block diagram of a continuous dehydrogenation reactor.

FIG. 6 illustrates the turnover number (TON), i.e., the amount of hydrogen released, by a catalyst that is exposed to a 4M formate solution, over time. The graph compares a used catalyst with a catalyst that was reactivated by air.

FIG. 7 illustrates the TON reached by a catalyst that is exposed to a 4M formate solution, over time. The graph compares different catalysts reactivation processes.

FIGS. 8a and 8b illustrate the TON reached by a catalyst that is exposed to a 4M formate solution, over time. The graph compares different catalysts reactivation processes by two different acids.

FIG. 9 is a photograph showing a reaction vessel of the dehydrogenation step.

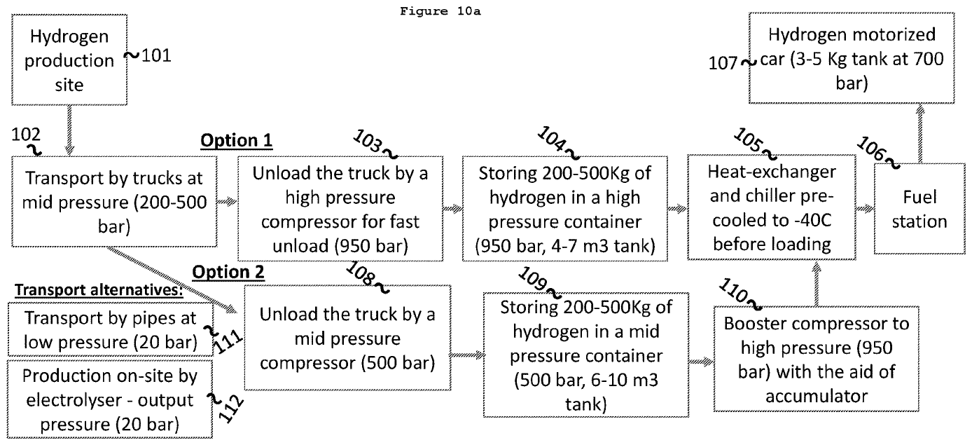

FIGS. 10a and 10b illustrates in a conceptual manner, the current hydrogen on-demand system vs. the newly suggested system.

FIG. 11 shows the effect of addition of an alkaline agent on the dehydrogenation reaction.

### DESCRIPTION OF THE INVENTION

Hydrogen storage is one of the most important challenges of today's energy industry. A valid and reproducible storage and release of hydrogen is a key point in the ability to produce clean energy efficiently in a reasonable cost.

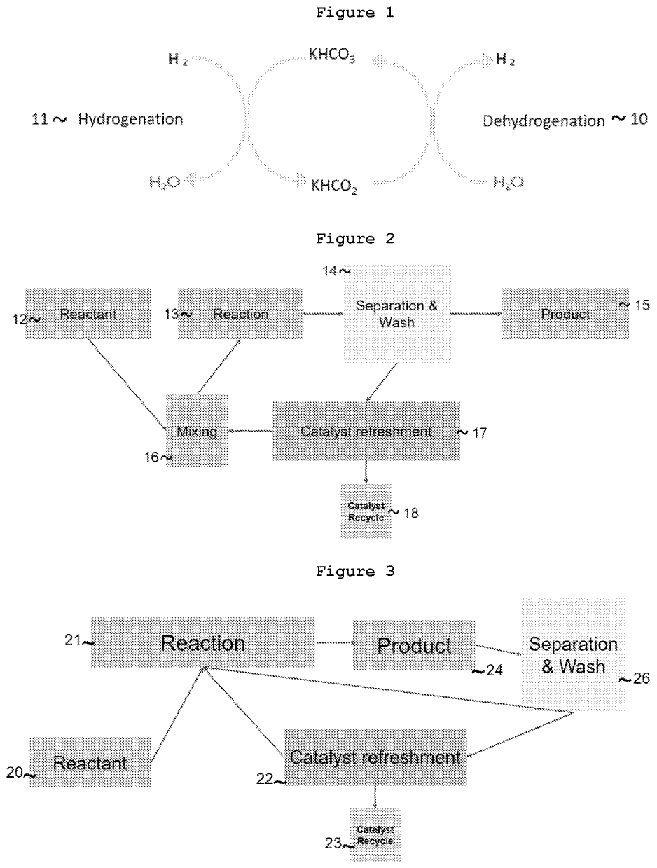

FIG. 1 illustrates the formate-bicarbonate cycle for hydrogen and energy storage. On the left side of the figure an alkali metal salt of bicarbonate is hydrogenated by hydrogen to produce water and formate 11 and on the right side of the figure, water react with the alkali metal salt of the formate and produce bicarbonate and hydrogen 10. Both sides of the cycle have low reaction energy making it easy to complete a full cycle without significant side reactions.

The dehydrogenation process of formate 11 occurs in the present of a catalyst. The catalyst can be a Pd or Pt based catalyst but other transition metal catalysts were used and found to be effective. The catalyst can be distributed on any substrate and a typical substrate for the catalyst is activated carbon. Other options can be SiO₂, TiO₂, or even a metallic substrate such as Al, Cu or any other metal, either neat or with coating made of activated carbon on these metals.

For effective dehydrogenation of the formate 11 and the water a low reaction temperature is needed, and a typical value of 30-90 degrees Celsius were used before. At lower temperature the reaction rate is lower and at higher temperature there is a significant increase in side reactions.

The hydrogenation process reaction 10 parameters are almost as mild as the parameters of the dehydrogenation process. The reaction temperature of the hydrogenation process can be controlled at the range of 20-40 degrees Celsius.

However, since this is an equilibrium reaction as the reaction goes forward the reverse reaction is increasing, limiting the conversion. Therefore, increasing the pressure of the hydrogen decreases the reverse reaction and increases the overall conversion of the hydrogenation process. The typical values of the hydrogen pressure for that process are 10-20 atmospheres a relatively low pressure for that kind of processes.

To keep the cycle as green as possible it is best to use water and no other solvent. However, both of the reaction can proceed in other solvents as long as water are present at the dehydrogenation reaction 10 as a reactant.

In aqueous solutions a key parameter for the reaction is the salts solubility. Both formate and bicarbonate salts are highly soluble in water. However, the solubility of formate is much higher than the solubility of bicarbonate. At room temperature a formate solution in water can by soluble up to 15.7M as bicarbonate solution at the same conditions is soluble up to 3.4M and above that a sedimentation of bicarbonate will start.

The difference in solubility creates a very big challenge in high molar concentration of formate as the bicarbonate sedimentation starts and the reaction is no longer a liquid-to-liquid reaction. Since the heterogenous catalyst is also solid a good separation procedure between the solid bicarbonate and the catalyst is of great importance for the scale-up of the system.

An important parameter for the scale-up of the system is the catalyst refreshment and recycling system. As explained that main issue was overlooked by earlier publications and the present invention is focused on the ability to refresh and recycle the catalyst in the formate-bicarbonate system in a reproducible and scalable way.

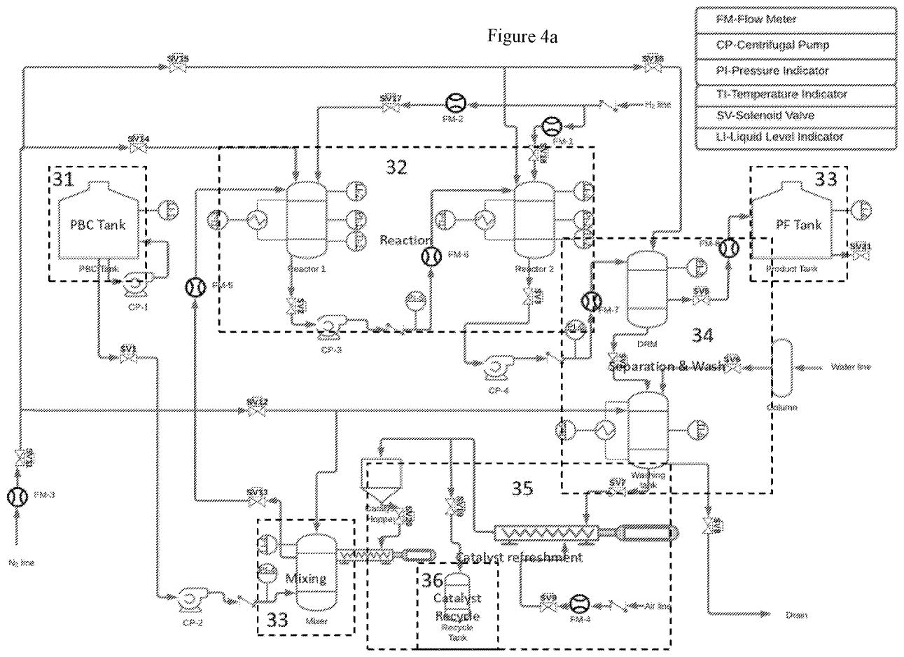

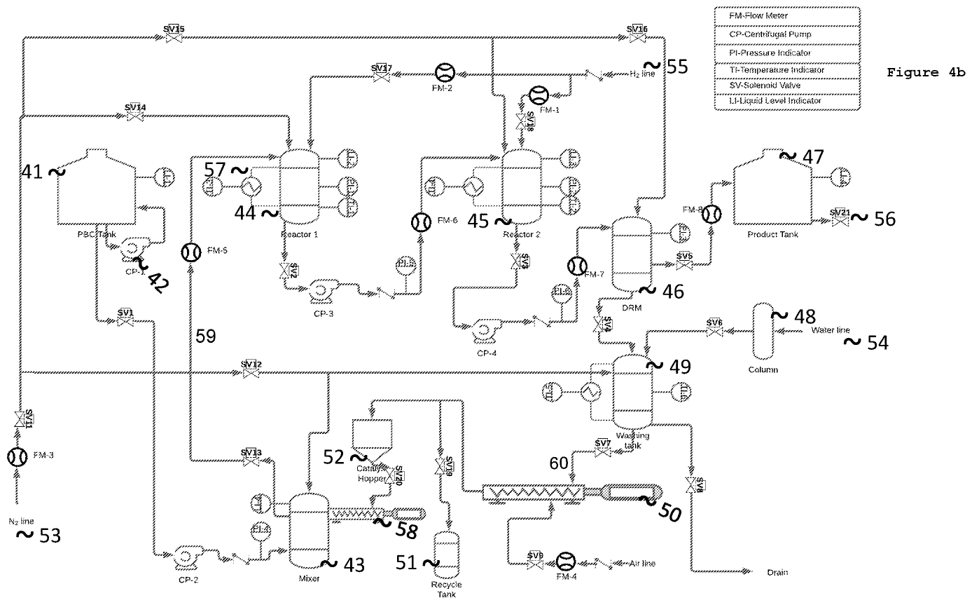

FIGS. 2 and 3 illustrate block diagrams of the system, taking into account all the specific characteristics of the formate-bicarbonate energy cycle system.

FIG. 2 illustrates by a block-diagram the hydrogenation of bicarbonate to formate. That side of the equation will be named here “storage” since in that side of the reaction the hydrogen is stored inside the formate for later use.

The storage process characteristics at a high molar concentration (10-14M) of the system are:
a. The reactant 12, bicarbonate is above its solubility fraction in water and therefore it is a two-phase reactant: a solid pure bicarbonate salt and a solution of bicarbonate in water at 3.4M (at room temperature; solubility increases with increasing temperature).
b. The product 15 is an aqueous formate solution (the solubility of formate in water is much higher than that of the bicarbonate, as explained above), and therefore the reaction is a slurry to liquid reaction.
c. The storage reactor 13 is pressurized by the hydrogen gas. Therefore, it is useful to mix the catalyst with the bicarbonate downstream to the hydrogenation reactor. The mixing 16 is also needed to introduce additional catalyst to the reaction.
d. The separation process at the end of the reaction 14 is a liquid-solid separation where the liquid is formate that is transferred to the product tank 15 and the solid is the catalyst that needs to be refreshed after each cycle 17.
e. The refreshment and recycling section is an important feature of the system since the catalyst cost is the main cost of the system and continuous refreshment prolongs the catalyst usage and increases the financial legitimacy of the system.
f. Active catalyst is refreshed on site to reduce costs 17 and a catalyst that is no longer active is recycled on factory 18.

The separation process can be done inline between the reaction and the product as shown in FIG. 2. However, another valid possibility is to separate the catalyst from the formate offline. In that case the product tank 15 is positioned immediately downstream the reactor 13 and the separation and wash 14 is downstream to the product tank, returning the liquid part back to the product tank and the catalyst to refreshment 17.

FIG. 3 illustrates by a block-diagram the dehydrogenation of formate to bicarbonate. That side of the equation will be named here “release” since in that side of the reaction the hydrogen is release from the formate and used as energy on the same site.

The release process characteristics at a high molar concentration (10-14M) of the system are:
g. The reactant 20, formate is below its maximum solubility in water and therefore it is a liquid reactant (i.e., an aqueous solution).
h. The product 24 is bicarbonate which will above its solubility limit in water and therefore it is a two-phase product: a solid pure bicarbonate salt and a solution of bicarbonate in water at 3.4M.
i. The release reactor 21 is heated to 50-90 degrees Celsius to increase the reaction rate but the formate and the catalyst will react at lower temperatures and therefore cannot be mixed before to the reactor. The mixing will be done inside the reactor.
j. The separation process at the end of the reaction 26 is a liquid-solid-solid separation where the liquid is formate that is returned to the product tank 24 and the solids are both the catalyst and the bicarbonate that must be separated as well. The solid be carbonate should stay in the product tank and the catalyst needs to be refreshed after each cycle 22.
k. The refreshment and recycling section is an important feature of the system since the catalyst cost is the main cost of the system and continuous refreshment prolongs the catalyst usage and increases the financial legitimacy of the system.
l. Active catalyst is refreshed on site to reduce costs 22 and a catalyst that is no longer active is recycled on factory 23.

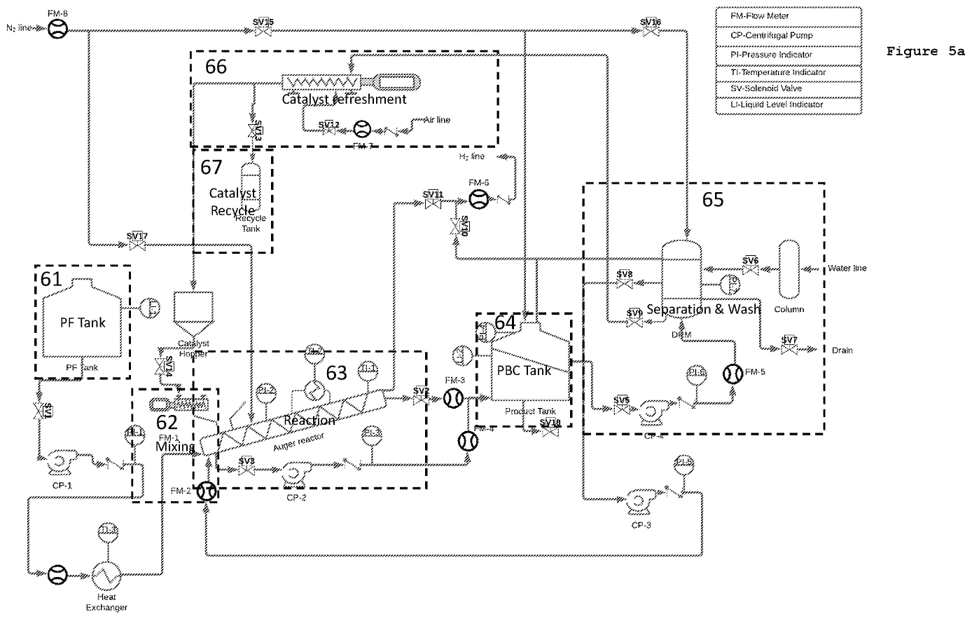

FIGS. 4a and 4b illustrate an example of a continuous storage system that both produce the formate from bicarbonate and also continuously refresh the catalyst to increase the productivity of the system. Major units/operations are encircled by dashed lines in FIG. 4A.

The reactant tank is the potassium bicarbonate salt tank 31 that flows through a mixing unit 33 to the reactors 32. After the reaction the product and the catalyst are separated 34, the liquid goes to the potassium formate tank 33 and the catalyst is washed, refreshed 35 and returned to the reaction by the mixing unit 33.

An example of the characteristics of the storage system is shown schematically at FIG. 4b in details. The reactant tank 41 is a potassium bicarbonate tank at high concentration. Typically, a 7-10M concentration and in other cases 11-15M of salt concentration. Therefore, the most of the salt in the tank is in solid state and a mechanism that prevents clogging is needed. The pump 42 below the reactant tank is one example of how to prevent the slurry from clogging the pipes, as it will continue to circulate the slurry during the reaction to create a uniform slurry feed to the reactor. Other options for the same purpose of mixing the slurry can be a lifting screw to distribute the solids in the solution or an addition of mixing equipment inside the reactant tank.

The slurry will be mixed with a catalyst in the way to the first reactor in a mixing tank 43. The mixing tank can be replaced by other methods to mix solids into liquids for instance a vortex pipes or a screw.

The purpose of the mixer is dual: first, it enables to feed also the catalyst to the reactor continuously although the reactor is pressurized and second it allows to mix the bicarbonate with the catalyst before the reactor.

The catalyst enables the reaction, however, with time its activity is reduced and a refreshment cycle is needed to regain the best performances of the catalyst. To enables that, a fraction of the catalyst is removed from the reactor during each time segment and in order to keep the reaction rate constant, a similar amount of catalyst should be added to the reactor at the same time segment. The mixer tank purpose is to add the catalyst after refreshment at the correct rate.

During the reaction the amount of catalyst inside the reactor should be constant and the conditions of the catalyst should be constant too. To enable that, the catalyst refreshment should continue during the reaction, i.e., an additional amount of catalyst should be out the reactor during the reaction at a refreshment cycle. The ratio between the amount of catalyst inside the reactor and the catalyst at refreshment cycle depends on the residence time inside the reactor and the residence time to refresh a catalyst. A typical values is 1:1 to 1:2 for catalyst inside:outside the reactor. However, a better and faster refreshment cycles can reduce the ratio to 1:0.1 to 1:0.3, and in turn to reduce the overall cost of the system.

From the mixer the slurry is pushed against pressure into the first reactor 44. The pressure is of hydrogen gas 55 that is a reactant to the hydrogenation reaction and it need to be a high pressure to allow a good conversion, preventing the spontaneous reverse dehydrogenation reaction of the formate back to bicarbonate. A typical pressure is 10 bar, a 10-20 bar or 20-30 bar pressure are better but they also cost energy and a 10 bar pressure is a good compromise between cost and performances.

The reaction produces heat and for control issues a heat exchanger 57 is used to maintain the same temperature in the reaction tank. A typical temperature is 25-35 degrees Celsius. Lower temperature is preferred to reduce the reverse reaction.

The reaction tank can be monitored by several sensors. The most important parameters that need to be monitored are the temperature at the reactor, the pressure and the amount of material inside the reactor. To monitor the last a height sensor or a wet point sensor can be used.

The feed stream to the reactor contains solid catalyst and a bicarbonate slurry. The solid part of the bicarbonate slurry should stay inside the reactor until it is consumed by the reaction and only the liquid part should continue to the next stage. To this end, size filter is placed close to the exit point of the reactor, preventing from the solid bicarbonate to leave the first reactor and allowing transfer of the catalyst to the next reactors. The conditions in the first reactor tank 44 are determined by the residence time and the hydrogen pressure. Due to the filter, the flow out concentration is set to a maximum of 3.4M of bicarbonate and at a typical reaction when the input stream is 10M of bicarbonate the minimum conversion is 66%.

The filter also forces the output stream of the reactor to be liquid and therefore the input stream to the next reactor 45 is no longer a slurry but a liquid with catalyst.

The second reactor 45 could be a similar CSTR reactor as the first reactor. However, since the reaction is only in the liquid phase another reactor options are possible for that part of the process. Examples will be a PFR reactor or a static mixer or an auger reactor at low temperature.

The pressure at the second reactor should be higher than the pressure in the first reactor to increase the conversion even higher and no filtration is needed.

From the second reactor 45 an output stream is fed into a liquid solid separator 46. The separator is inline with the process and therefore it continuously transfers the product as an output stream to the product tank 47. However, a filter is collecting the solid part of the catalyst and every time segment it pushes the catalyst cake to a washing tank 49 with the aid of a nitrogen stream 53 (to prevent explosion). The separator can be a for instance a CONTIBAC filter from DrM.

The product tank 47 is a liquid vessel at a similar size to the reactant tank and the product liquid can be used through the exit pipe 56.

The catalyst that leaves the separator 46 is pushed to a washing tank 49. It is extracted from the reaction process and it is transferred to the refreshment process.

The refreshment procedure will be explained in detail in the next figures. However, here we focus on the process parameters of the refreshment cycle.

The first step of the refreshment cycle is washing the catalyst from traces of format and bicarbonate to prevent hydrogen production during the refreshment cycle. To this end, water 54 are purified in a column 48 and fed to the washing tank 49. The additional water can be reused for next washing cycle and can flow to drain.

After first water wash additional washes can be done to the catalyst by acids. FIG. 4b is only an example of the process and therefore the acid wash is not shown, but acids wash can be introduced by the same means at the same process point as the water wash. Therefore, the water wash should be considered as an example of any additional wash by liquid material.

Another point is the treatment temperature. The water or the acids could be used in temperatures above room temperature. A typical wash temperature is 30-50 degrees Celsius, other treatment could be done at 50-80 degrees Celsius and higher temperatures can be used.

From the washing tank 49 the catalyst is transferred as a wet cake to a dryer. The dryer can be a conveyor with heated elements or IR lamps but a simpler approach can be a screw with an air stream. The air purpose is both to dry the catalyst as well as oxidizing it. Therefore, a simple air can be as very useful and other oxidizing agent such as chemical vapor or UV heating or charging are also valid here.

The catalyst is promoted to a hooper 52 and fed back to the mixing tank 43 by a feeding screw 58. By that the refresh cycle is completed and the catalyst joins back to the reaction cycle.

After a long period of catalysis cycles and refresh cycles the catalyst activity will be too low and a full recycling of the catalyst will be needed. At that point, the used catalyst will be fed to the recycle tank 51 and a new catalyst will be added directly to the hooper 52.

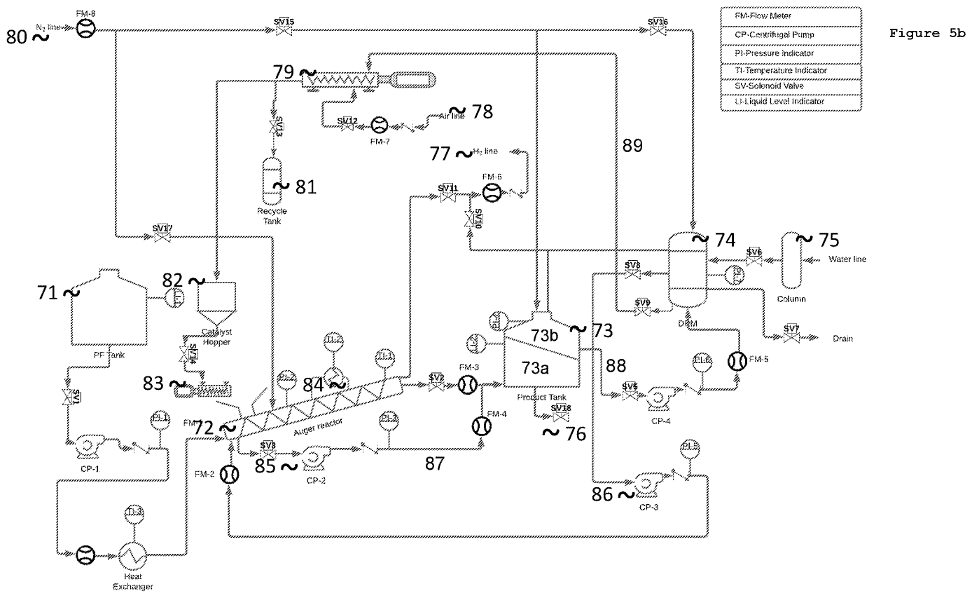

FIGS. 5a and 5b illustrate an example of a continuous release system that both release the hydrogen from the formate and also continuously refresh the catalyst to increase the productivity of the system. Major units/operations are encircled by dashed lines in FIG. 5A.

The reactant tank is the potassium formate salt tank 61 that flows directly to the reactor 63 and mix inside it with a fresh catalyst 62. After the reaction the product and the catalyst flow to a product tank 64. In that example the product is separated from the catalyst by a continuous flow of products that leave the product tank 64 and flows to a separator 65. The liquid returns to the product tank from the separator, while the catalyst is washed, refreshed 66 and return directly to the reactor 63 by the mixing unit 62.

An example of the characteristics of the release system is shown schematically at FIG. 4b in details. The reactant tank 71 is a potassium formate tank at high concentration. Typically, a 7-10M concentration and in other cases 10-15M of salt concentration. However, this concentration is still below the sedimentation concentration and therefore the formate is still in liquid phase completely.

Another possibility, not shown in the example, is to use a concentration that is above the 15.7M where some or most of the salt in the tank is in solid state and a mechanism that prevents clogging will be added. For instance, a pump below the reactant tank will be added to prevent the slurry from clogging the pipes it will continue to circulate the slurry during the reaction to create a uniform slurry feed to the reactor. Other options for the same purpose of mixing the slurry can be a lifting screw to distribute the solids in the solution or an addition of mixing equipment inside the reactant tank. In that case, the slurry will be mixed with a catalyst in the way to the first reactor in a special mixing unit, because the reaction between the formate and the catalyst starts instantly at non-pressurized conditions.

The catalyst enables the reaction, however, with time its activity is reduced and a refreshment cycle is needed to regain the best performances of the catalyst. To enable that, a fraction of the catalyst is removed from the reactor during each time segment and in order to keep the reaction rate constant, a similar amount of catalyst should be added to the reactor at the same time segment.

The mixing process in the entrance to the reactor 72 controls the correct doses of refresh catalyst and formate solution to maintain the same catalyst concentration and conditions during the reaction.

The feed of the catalyst to the reactor 72 must be done from a close unit where a flow of nitrogen 80 or other inert gas will replace air to maintain a safe process flow.

During the reaction the amount of catalyst inside the reactor should be constant and the conditions of the catalyst should be constant too. To enable that the catalyst refreshment should continue during the reaction, i.e., an additional amount of catalyst should go out of the reactor during the reaction to the refreshment cycle. The ratio between the amount of catalyst inside the reactor and the catalyst at refreshment cycle depends on the residence time inside the reactor and the residence time to refresh a catalyst. A typical value is from 1:1 to 1:2 for catalyst inside:outside the reactor. However, better and faster refreshment cycles can reduce the ratio to 1:0.1 to 1:0.3, and in turn to reduce the overall cost of the system.

The reaction between the catalyst and the formate consumes heat and therefore a heat exchanger 84 is used to control the temperature in the reaction tank. A typical temperature is 50-70 degrees Celsius, it can also be 70-90 degrees Celsius. At lower temperatures the reaction is too slow and as the temperature increases, side reaction may occur.

The reaction tank can be monitored by several sensors. The most important parameters that need to be monitored are the temperature at the reactor, the pressure and the amount of material inside the reactor.

The reactor 72 can be a CSTR reactor for a good mixing of the materials. However, a static mixer or a low temperature auger reactor with a screw can be a better choice for the release reactor because the heating can be more efficient at that kind or reactors. In those reactors, it is also possible to increase the temperature with the propagation inside the reaction, a significant advantage that can increase the reaction conversion. As the residence time and the reaction temperature are controlled an optimum conversion can be achieved.

During the reaction a solid bicarbonate is formed inside the reactor. The solid part of the bicarbonate can sediment and extract out of the reactor during the reaction, increasing the conversion of the reaction to the theoretical limit of 100%. For that end an additional stream 85 is shown, extracting material from the reactor. Another stream 86 is added to compensate for the extract by return stream from the separator 74.

From the reactor 72 a liquid output stream is fed into a product tank 73 and another gas stream of hydrogen is harvested at sent to use 77.

Inside the product tank 73 there is a mixture of solid bicarbonate, solid catalyst and a liquid mixture of formate and some bicarbonate (depends on the conversion). To create a good separation between the catalyst and the solid bicarbonate a filter is added at the product tank, allowing the solid bicarbonate to sediment (at 73A) and keeping the catalyst inside the solution (73B) to feed into the separator 74.

The separator is not in line with the process and therefore it can work in a batch cycles, separating the catalyst from the formate solution and washing the catalyst alternately. During the separation cycle the formate can flow back to the product tank 73 directly, or better, to the reactor 72 for a second pass as show in the figure by stream 86.

Inside the separator 74 a filter is mounted, collecting the solid part of the catalyst and every time segment the catalyst is pushed with the aid of a nitrogen stream 80 (to prevent explosion) to the dryer unit 79. The separator can be a for instance a CONTIBAC filter from DrM.

The product tank 73 is a liquid vessel at a similar size to the reactant tank and the product, a slurry of potassium bicarbonate can be used through the exit pipe 76.

The first step of the refreshment cycle is washing the catalyst from traces of format and bicarbonate to prevent hydrogen production during the refreshment cycle. To this end, water is purified in a column 75 and fed to the separator 74 during the washing cycle in the separator. The additional water can be reused for next washing cycle and can flow to drain.

After first water wash additional washes can be done to the catalyst by water or acids. FIG. 4b is only an example of the process and therefore the acid wash is not shown, but acids wash can be introduced by the same means at the same process point as the water wash. Therefore, the water wash should be considered as an example of any additional wash by liquid material.

Another point is the treatment temperature. The water or the acids could be used in temperatures above room temperature. A typical wash temperature is 30-50 degrees Celsius, other treatment could be done at 50-80 degrees Celsius and higher temperatures can be used.

From the separator 74 the catalyst is transferred via 89 as a wet cake to a dryer 79. The dryer can be a conveyor with heated elements or IR lamps but a simpler approach can be a screw with an air stream 78. The air purpose is both to dry the catalyst as well as oxidizing it. Therefore, a simple air stream can be as very useful and other oxidizing agent such as chemical vapor or UV heating or charging are also valid here.

The catalyst is promoted to a hooper 82 and fed back to the reactor 72 by a feeding screw 83. By that the refresh cycle is completed and the catalyst joins back to the reaction cycle.

After a long period of catalyzing cycles and refresh cycles the catalyst activity will be too low and a full recycling of the catalyst will be needed. At that point, the used catalyst will be fed to the recycle tank 81 and a new catalyst will be added directly to the hooper 82.

A key point in the present invention is the refreshment cycle of the catalyst. The process flow is designed to enable a prolong working cycles of the catalyst and mitigate the main concern of the system, i.e., early poisoning of the catalyst.

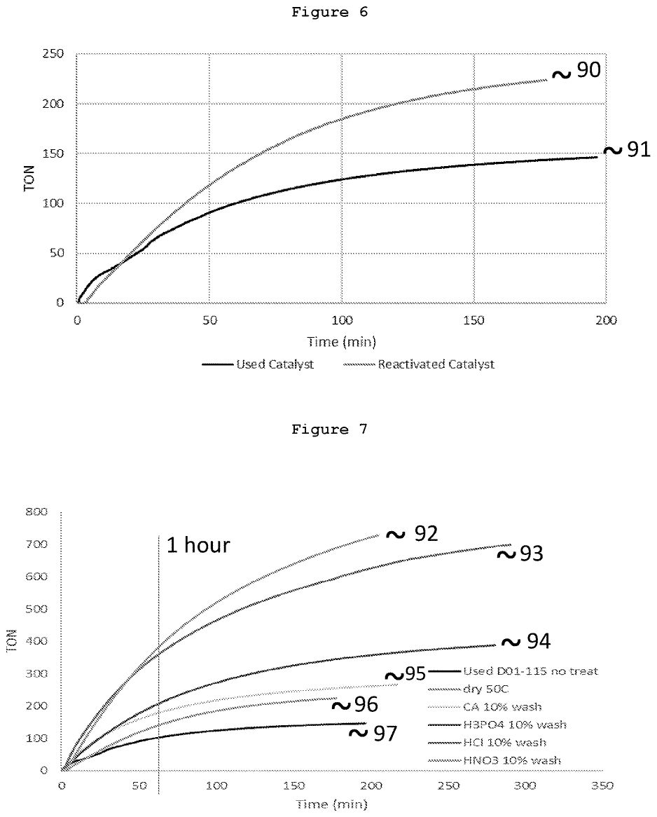

Different catalyst refreshment procedures can be used to prolong the life cycle of the catalyst and FIGS. 6-8 illustrates different examples of treatments to reproduce the initial conditions of the catalyst.

The catalyst reactivation process can be tested by the activation before and after the treatment. A simple way to illustrate the activation is by using the turnover numbers (TON) of the catalyst and the turnover frequencies (TOF) at each time segment during the reaction. Both parameters describe different properties of the catalyst activity and therefore the TON and the activity will be used later as synonyms.

The TON describes the average number of active sites that preform a full reaction cycle for each gram of catalytic metal present in the catalyst. At the first stage of the process all the sites are new and can perform a full reaction cycle and therefore there is an increase in the TON. However, with the passage of time, some of the sites become inactive (poisoned) and therefore the TON increases at a lower rate. After some time, most of the sites stops their activity and the TON is almost stable. Almost, because some activity is maintained for a very long period. That behavior can be seen very clearly in FIGS. 6-8 where the TON is saturated with time no matter what treatment is used to reactivate it.

The derivative over time of all the graphs is the TOF of the catalyst which is a crucial parameter in the design of the refreshment cycle. The best performances of the catalyst are at the first stage of the reaction where the TON is increasing rapidly. Therefore, for the design of the process it is crucial to put a new or refreshed catalyst into the reactor continuously as suggested by the current invention so that the catalyst performances will be best during all the reaction of not only in the first stages. At the same time, by refreshing continuously the rate of hydrogen production remains constant—an important issue for the energy consumers.

FIG. 6 illustrates the most basic treatment of a catalyst: a wash in water and drying by a stream of air. The washing water should be deionized water to keep the catalyst intact and the water could be in room temperature. However, a higher water temperature is better for the process because traces of potassium salts sedimented on the catalyst and the solubility constant of both salts is increasing with the temperature. A typical washing water temperature is 30-50 degrees Celsius it is also possible to wash at 50-80 degrees Celsius, or even at higher temperature at pressurized tanks.

The reactivated catalyst 90 that is presented at FIG. 6 was reactivated by washing in water and drying in air stream. The graph indicates clearly that the reactivated catalyst performances were better than another used catalyst that wasn't reactivated 91.

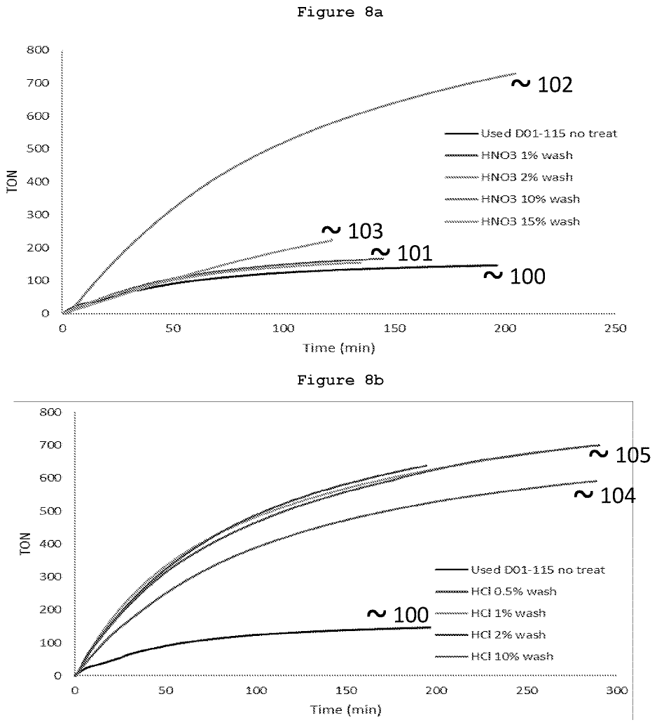

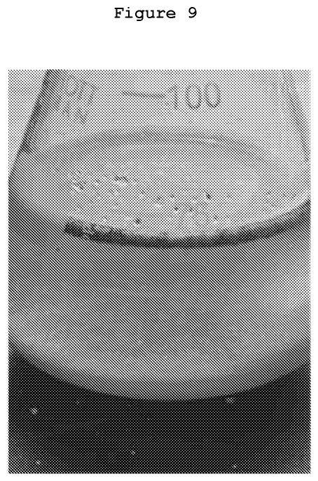

The reactivation process can be done also by other means and not only by air and water. FIGS. 7 and 8 illustrates other examples of catalyst reactivation processes.

FIG. 7 present a comparison between several different refreshment procedures. The high deviation of the TON after 1 hour of reaction between the different treatments implies that the refreshment treatment is crucial for the success of the continuous refreshment process.

The untreated used catalyst shows the lowest activity 97, the water wash at 50C shows a better activity 96, but better activity is achieved with the aid of acids 92-95. Organic acids like citric acid 95 shows lower reactivation ability than inorganic acids and hydrochloric acid 93 and nitric acid 94 are better than phosphoric acid 95.

FIG. 8 also illustrate the acid concentration effect in two different acids:nitric acid (FIG. 8a) and hydrochloric acid (FIG. 8b).

In the case of the nitric acid a comparison between the untreated catalyst 100 and the catalyst that was washed by nitric acid up to 2% concentration 101, showed no effect on the overall catalyst reactivation. However, at a concentration of 10% the nitric acid increased the catalytic activity significantly 102. The graph shows that there is an optimum to reactivation by nitric acid because at higher concentrations the refreshment influence on the catalyst activity declined.

In the case of the hydrochloric acid even small concentration of the acid had a strong effect on the catalytic activity 104, and higher concentration of hydrochloric acid had only small additional effect on the catalytic activity 105.

In a typical hydrogenation process a tank of 50-100 m³, preferably a 70 m³ is filled with 4-14M, preferably 10M of potassium bicarbonate salt slurry is flowing in a rate of 50-150 liter/min, preferably 120 liter/min by a pump into a mixing tank. At the same time 2-5 Kg/min, preferably 3.2 Kg/min of catalyst is pushed by a feeding screw under nitrogen conditions into the same mixing tank. The mixed slurry is flowing from the mixing tank into a 500-1500 liter, preferably 1000 liter CSTR reactor under pressure of 5-20 bar, preferably 10 bar of hydrogen gas. The slurry is mixed for a residence time of 3-10 min, preferably 6 min, filling 300-700 liter of the tank volume and preferably 620 liters. The tank is then stabilized at the same volume where 50-150 liter/min, preferably 130 liters/min of slurry enters into the reactor and 50-150 liter/min, preferably 130 liters/min of liquid leaves the reactor. The liquid is 50-70% formate and 30%-50% bicarbonate that goes to a second reactor at a pressure of 10-50 bar, preferably 20 bar for another 5-15 min, preferably 10 min to increase the conversion to 90%. The final product goes to a separator at a rate of 50-150 liter/min, preferably 130 liters/min and the liquid part flows continuously into the product tank at a rate of 50-150 liter/min, preferably 120 liters/min. At the separator the catalyst is filtered and pushed once in a while into the washing tank in a rate of 5-15 liter/min, preferably 10 liter/min of wet catalyst. The catalyst is washed in the washing tank by 10-30 liters, preferably 20 liters of distilled water at a temperature of 30-60 degrees Celsius, preferably 50 degrees and feed into a dryer. Air flow is drying the water from the catalyst for 10-25 min, preferably 20 min while a screw pushes the catalyst to the a hooper continuously. From the hooper the catalyst feeds the mixing reactor at a rate of 2-5 Kg/min, preferably 3.2 Kg/min completing the refreshment cycle.

In a typical dehydrogenation process: a tank of 50-100 m³, preferably 70 m³ is filled with 4-14M, preferably 10M potassium formate salt slurry is flowing in a rate of 50-150 liter/min, preferably 120 liter/min by a pump into a reactor. At the same time 2-5 Kg/min, preferably 3.2 Kg/min of catalyst is pushed by a feeding screw under nitrogen conditions into the same reactor. The liquid flows into a 1000-3000 liters, preferably 2000 liters low temperature Auger reactor at a temperature of 30-60 degrees Celsius, preferably 70 degrees Celsius. The slurry is mixed for a residence time of 5-20 min, preferably 10 min, filling a 500-2000 liters, preferably 1200 liters from the reactor volume and then stabilized at the same volume where 50-150 liter/min, preferably 120 liters/min of formate and 2-5 Kg/min, preferably 3.2 Kg/min of catalyst enters into the reactor and 50-150 liter/min, preferably 130 liters/min of slurry leaves the reactor. The slurry is 70-90% bicarbonate and 10-30% formate with catalyst. The final product 50-150 liter/min, preferably 130 liters/min goes to a product tank and there it is separated. The separator is working off-line at a rate of 100-300 liter/min, preferably 260 liters/min performing two tasks: first, separating between the catalyst and the solution in the tank and returning the liquid to the product tank a rate of 100-300 liter/min, preferably 260 liters/min and then washing the catalyst with distilled water at a rate of 10-30 liters, preferably 20 liters of at a temperature of 30-60 degrees Celsius, preferably 50 degrees Celsius. Every 0.5-5, preferably 1 min the separator changes its task. At the separator the catalyst is filtered and pushed every 0.5-5, preferably 1 min into the dryer. Air flow is drying the water from the catalyst and a screw push the catalyst to the a hooper. From the hooper the catalyst feeds the mixing reactor at a rate of 2-5 Kg/min, preferably 3.2 Kg/min completing the refreshment cycle.

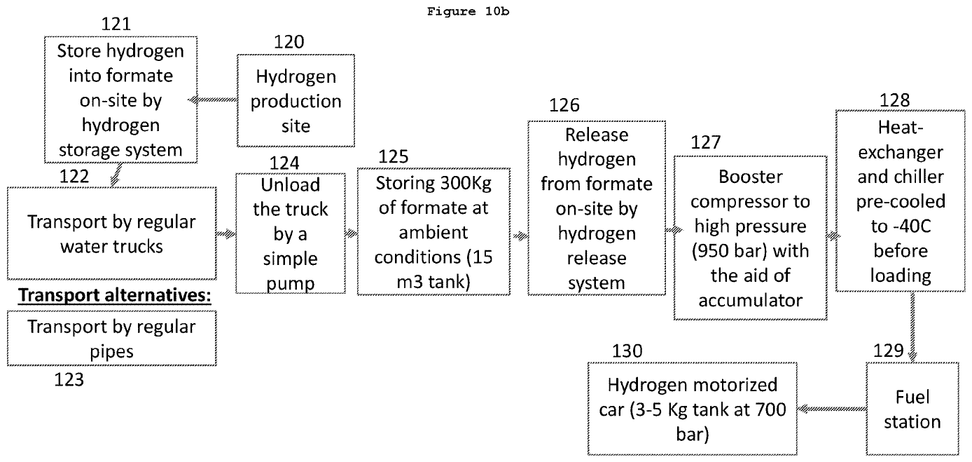

FIG. 10a illustrates in a conceptual manner, the current hydrogen on-demand system.

In the current process the hydrogen is produced on some distant site in a large factory 101 or on-site by small electrolyzes 112. The production in a distant location is both safer and cheaper, however, the complexity of hydrogen transport and the high cost of its transport create some financial and environmental disadvantage.

The transport of hydrogen from the production location to the fuel stations can be done in trucks 102 or by pipes 111. The transport by trucks 102, has to be done at high pressure to efficiently move large amounts of hydrogen to the fuel stations. However, high pressure tanks costs are high and there is also a limit on the amount of hydrogen that can be carried each time from safety reasons. Therefore, the designed trucks pressure is expected to be 200-500 bars and to carry ~20 metric cube of hydrogen.

The price per 1 Kg of hydrogen to travel on average 50 Km on a truck like the one described above is going to be 1.4$/Kg of hydrogen with current trucks technology and could be reduced with a significant effort to 0.6$/Kg of hydrogen. The high transport cost in the trucks increases significantly the price of the hydrogen for the customers and decrease the tendency toward the hydrogen energy solution.

Another way to transport the hydrogen is by pipes 111. The use of hydrogen in pipes across long distances might create an even bigger safety issues, whereas any damage to the pipes with time or by accident can create an explosive danger. The use of pipes also reduces the allowed pressure of the hydrogen to 20 bars and creates an additional cost to pressurize the hydrogen gas to high pressure on site.

The hydrogen that arrived at the fuel station by trucks 102, pipes 111 or produced on-site by electrolyzer 112, has to be unloaded and stored and released on demand. To allow that, two different options of compressors can be used. The first option, is a high pressure compressor to hold the hydrogen gas at 950 bars on-site 103, the second option is a medium pressure compressor the will hold the hydrogen gas a 500 bars 108. The difference between the two options is that in the first option, the hydrogen is already ready for distribution but it is held in a very expensive container, on the second option the container cost is lower but the hydrogen is not ready for distribution and it needs to be compressed to 950 bars before distribution in a smaller booster compressor on-demand.

In the first option, a tank of 4-7 cubic meters is used to store the hydrogen at 950 bar 104, and in the second option a tank of 6-10 cubic meters is used to store the hydrogen at 500 bar 109.

The cost of the compressors and all other parts of the system is estimated in Table 2. Both the high pressure and mid pressure containers costs are on the range of 1000-1500K$, while the mid pressure is at the lower end of that range and the high pressure compressors are at the higher end of that range. The same goes for the storage cost of the hydrogen, where lower pressure containers at the correct size are expected to be at the lower end of the range while the high pressure containers at the same size are expected to cost ~500K$. The booster compressor 110 cost is insignificant in comparison to the above costs and its estimated cost is included in the general costs that are connected to the amounts of hydrogen being compressed, and estimated to be 0.04$/Kg of hydrogen.

TABLE 2
Expected costs—current system

| | | Hydrogen | |
|---|---|---|---|
| Current | System | amount | |
| system | cost | related cost | Notes |
| Hydrogen fast | 1000K- | 0.05$/Kg | Option 1 costs are at the |
| compression | 1500K $ | Hydrogen | higher end of the range |
| | | | and v.v. for option 2 |
| Hydrogen | 300- | 0.02/Kg | Specially designed storage |
| storage | 500K $ | Hydrogen | because of safety issues. |
| cost on-site | | | Option 1 costs are at |
| | | | the higher end of the |
| | | | range and v.v. for option 2 |
| Transport cost | Specially | 0.6-1.5$/Kg | Based on 50 Km |
| | designed | Hydrogen | of transport |
| | trucks | | |
| Hydrogen | | 0.04$/Kg | Similar for both option |
| booster | | Hydrogen | |
| compression | | | |
| and cooling | | | |

In both cases before the distribution the hydrogen is passed through a heat exchanger to pre-cool the gas to −40 degrees Celsius 105. After cooling, the hydrogen gas stream goes to the fuel station 106 and from there to the customer.

In the case where the customer is a high-pressure hydrogen gas car 107, hydrogen is supplied at 950 bar the hydrogen motorized car tank is kept at 700 bars.

FIG. 10b illustrates in a conceptual manner, the suggested hydrogen on-demand system.

In the suggested hydrogen on-demand system the hydrogen is produced in a distant location 120 to avoid safety issues at transport and storage. The produced hydrogen is stored on the production site by the hydrogen storing system that was disclosed in FIGS. 2 and 4 above in the form of a formate salt 121. Since the storing system is on the production site its size could be very big to allow hydrogen distribution to a significant number of fuel station. The size of the system reduces significantly the hydrogen storing price creating an attractive hydrogen energy alternative.

The formate salt that is produced on the production site is a non-hazardous material and it can be distributed to the fuel stations by a regular water trucks 122 with no limitations on size or safety. Even in the case of accident no damage from the formate can be done, no explosion or environmental issues are expected.

Another way to transport the formate from the production site to the fuel stations is by pipes 123. Again, with no safety issues.

To unload the trucks a very simple pump is needed 124 and no significant cost is involved with both the unloading and storing of the formate solution. A 300 Kg of hydrogen can be stored in a 15 cubic meter tank with no special safety issues. The tank can be a simple plastic tank 125 and the only significant additional cost at the fuel station is a small hydrogen release system 126 that was described above in FIGS. 3 and 5.

The expected cost of the hydrogen storing and release systems that will be used on the production site and on the fuel stations is expected to be on the range of 200-400K$ and to add additional cost of 0.5$/Kg of hydrogen. The transport cost is known and estimated to be 0.1$/Kg of hydrogen as any other general goods transport cost. The storage cost on-site is expected to be very low.

As in the case of the current solution a booster compressor 127 is needed to compress the release hydrogen gas to 950 bars. The cost is insignificant in comparison to the above costs and its estimated cost is included in the general costs that are connected to the amounts of hydrogen being compressed and estimated to be 0.04$/Kg of hydrogen.

In the suggested process before the distribution the hydrogen is passed through a heat exchanger to pre-cool the gas to −40 degrees Celsius 128. After cooling, the hydrogen gas stream goes to the fuel station 129 and from there to the customer.

In the case where the customer is a high-pressure hydrogen gas car 130, hydrogen is supplied at 950 bar the hydrogen motorized car tank is kept at 700 bars.

The cost estimation for the suggested system is presented in Table 3 below:

TABLE 3
Expected costs—suggested system

| | | Hydrogen | |
|---|---|---|---|
| Suggested | System | amount | |
| system | cost | related cost | Notes |
| Hydrogen storage | 200K- | 0.5$/Kg | Only the release system |
| and release | 400K $ | Hydrogen | is an invested needed |
| systems | | | for each fuel station |
| Transport cost | None | 0.1$/Kg | Based on 50 Km |
| | | Hydrogen | of transport |
| Hydrogen storage | Included | 0.002$/Kg | |
| cost on-site | in the | Hydrogen | |
| | system | | |
| Hydrogen booster | | 0.04$/Kg | Similar to option 2 at |
| compression and | | Hydrogen | current system |
| cooling | | | |

The tables illustrate the significant cost reduction on the suggested solution. It is also apparent that the suggested solution is significantly safer and therefore makes it possible to vision the hydrogen energy solution with no significant industrial changes.

### EXAMPLES

Example 1—refreshment treatment: 100 g of purified water was placed in a vessel with 10 g of hydrochloric acid and heated up to 50 degrees Celsius. 10 g of Pd/C catalyst (5%) was added to the vessel and the mixture was stirred for 5 min. After 5 min the catalyst was transferred to another vessel through as filer paper and collected on the filter paper. The catalyst was transferred to another vessel where additional 200 ml of purified water at a temperature of 50 degrees Celsius were added and the slurry was mixed for another 5 min. The slurry was filtered again and collected on a filter paper and then placed in a vessel where air flow at a rate of 10,000 ml/min was flowing on the catalyst for 10 min drying the catalyst.

Example 2—refreshment treatment: 100 g of purified water was placed in a vessel with 10 g of nitric acid and heated up to 50 degrees Celsius. 10 g of used catalyst was added to the vessel and the mixture was stirred for 5 min. After 5 min the catalyst was transferred to another vessel through as filer paper and collected on the filter paper. The catalyst was transferred to another vessel where additional 200 ml of purified water at a temperature of 50 degrees Celsius are added and the slurry was mixed for another 5 min. The slurry was filtered again and collected on a filter paper and then placed in a vessel where air flow at a rate of 10,000 ml/min was flowing on the catalyst for 10 min for drying.

Example 3—refreshment treatment: 500 g of purified water was placed in a glass beaker and heated up to 70 degrees Celsius. The used catalyst was placed in a plastic net bag inside the water for 1 h. After an hour the used catalyst was taken out of the beaker and dried at heated air at temperature of 80 degrees Celsius at a rate of 51/min for 30 min.

Example 4—refreshment treatment: 27 ml of 37% hydrochloric acid was added to a beaker of purified water up to a 1-liter total volume. 100 g of the solution was poured to another beaker and the used catalyst was placed in a plastic net bag inside the solution for 1 h. After an hour the used catalyst was washed in purified water until a neutral pH was observed. Then, the used catalyst was taken out of the beaker and dry at heated air at temperature of 80 degrees Celsius at a rate of 51/min for 30 min.

Example 5—refreshment treatment: 500 g of purified water was placed in a glass beaker and heated up to 70 degrees Celsius. The used catalyst was placed in a plastic net bag inside the water for 15 min. After that the used catalyst was taken out of the beaker and dried at heated air at temperature of 80 degrees Celsius at a rate of 51/min for 15 min.

Example 6—refreshment treatment: 27 ml of 37% hydrochloric acid was added to a beaker of purified water up to a 1-liter total volume. 100 g of the solution is poured to another beaker and the used catalyst was placed in a plastic net bag inside the solution for 15 min. After an hour the used catalyst was washed in purified water until a neutral pH was observed. Then, the used catalyst was taken out of the beaker and dried at heated air at temperature of 80 degrees Celsius at a rate of 51/min for 15 min.

Example 7—refreshment treatment: 30 g of catalyst was placed into a 500 ml reactor in a confined cup. A formate solution was pumped to the reactor and allowed to react at the reactor generating hydrogen from the formate and water solution. The rate of the hydrogen generation was monitored during all times and the system control stops the reaction when the rate of hydrogen was lower than a set point target. Then the reactor was evacuated from formate and water are fed to the reactor until it was filled with water. The water was heater in the way to the reactor by a heat exchanger to 70 degrees Celsius and stayed in the reactor for 10 min. After that, the water was evacuated from the reactor and a second washing cycle begins. After 3 cycles of wash the water was drained and air was allowed to flow into the reactor in a rate of 1000 ml/min for 10 min.

Example 8—refreshment treatment: 30 g of catalyst was placed into a 500 ml reactor in a confined cup. A formate solution was pumped to the reactor and allowed to react at the reactor generating hydrogen from the formate and water solution. The rate of the hydrogen generation was monitored during all times and the system control stopped the reaction when the rate of hydrogen was lower than a set point target. Then the reactor is evacuated from formate and water was fed to the reactor until it was filled with hydrochloric acid solution. The hydrochloric acid solution concentration was 1% wt (27 ml of 37% hydrochloric acid was added to a beaker of purified water up to a 1-liter total volume) and it stayed inside the reactor for 10 min. After that, it was evacuated to drain and the reactor was filled by purified water. The water flowed through a heat exchanger in the way to the reactor and heated up to 70 degrees Celsius and stayed in the reactor for another 10 min. After that, the water was evacuated from the reactor and the pH of the water was measured if the pH was not neutral another washing cycle starts. After several cycles of wash, the water neutralizes completely and air was allowed to flow into the reactor in a rate of 1000 ml/min for 10 min.

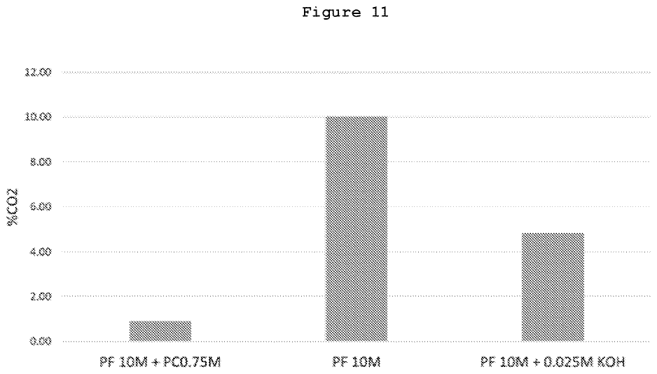

Example 9—Discharging procedure: 70 grams of potassium formate was added to 50 ml of water and stirred to give a clear solution. 2.12 g of Pd/C (2%) catalyst was added to the solution and the solution was placed in 100 ml beaker. An alkaline agent (0.025 M KOH or 0.75 M potassium carbonate) was added to reach a pH of 11. The beaker was heated to 70 degrees Celsius. Hydrogen gas evolved from the reaction and collected as an output stream, which was directed to a chamber and measured by a gas chromatography to determine the composition of the gas stream. After the reaction was completed, the chamber was washed again with nitrogen and the solution was filtered to separate the liquid from the catalyst and the bicarbonate. FIG. 11 is a bar diagram showing the % of CO₂ in the gas collected, working with 10M potassium formate (middle bar); 10M potassium formate+0.75 M K₂CO₃ (left bar) and 10M potassium formate+0.025M KOH (right bar). The results attest for the effect achieved by addition of an alkaline agent in minimizing CO₂ evolution, with K₂CO₃ emerging as especially useful alkaline agent for this goal.

### Preparations 1 to 6

In the next set of Examples, several preparations of Pd/C catalysts useful in the invention are described. The catalyst was produced by sequential procedure with two or three major steps, starting with commercial (or ground) activated carbon particles with diameter in the range 4 to 40 microns.

### Preparation 1

STEP 1—carbon activation: 10 grams of carbon was placed in a 250 ml beaker and 10% HNO₃ (100 ml) was added gently to the beaker. The mixture was stirred for 24 hours at 125° C. After the reaction, the mixture was added to 1000 ml of water, and the solid was filtrated and wash until neutral pH conditions.

STEP 2—catalyst preparation: 100 mg of palladium nitrate were added to a beaker. 600 ml of water were added gently, followed by addition of 1 g, of the activated carbon from STEP 1. Mixing is continued for 60 min. To a second beaker 100 ml of water were added with 1 gram of potassium formate. The second solution was gently poured to the first solution. The solution was stirred for another 24 h. The product was filtered and washed and then dried in an oven at 80° C., under nitrogen.

### Preparation 2

STEP 1—carbon activation: 10 grams of carbon was placed in a 250 ml beaker and 10% HNO₃ (100 ml) was added gently to the beaker. The mixture was stirred for 24 hours at 125° C. After the reaction, the mixture was added to 1000 ml of water, and the solid was filtrated and wash until neutral pH conditions.

STEP 2—catalyst preparation: 100 mg of palladium nitrate were added to a beaker. 600 ml of water were added gently. To a second beaker 100 ml of water were added with 1 gram of potassium formate and 1 g of the activated carbon from STEP 1. The second solution was filtered, and the soaked carbon was added to the first solution gently, followed by mixing for 60 min. The mixture was kept under stirring for another 24 h. The product was filtered, washed and dried in an oven at 80° C., under example air.

### Preparation 3

STEP 1—carbon activation: 10 grams of commercially available carbon was placed in a 250 ml beaker and 100 ml 10% NaCl solution was added gently to the beaker. The mixture was stirred for 24 h at temperature of 125° C. After the reaction the mixture was added to 1000 ml of water. The solid was separated by filtration and washed until neutral pH conditions.

STEP 2—catalyst preparation: 100 mg of palladium nitrate were added to a beaker. 600 ml of water are added gently, followed by addition of 1 g of the activated carbon from STEP 1. The mixture was stirred for 60 min. To a second beaker were added 100 ml of water with 1 gram of potassium formate. Then the second solution was gently added to the first. Stirring was kept for additional 24 h. The product was filtrated, washed and dried in an oven at 80° C., under air.

### Preparation 4

STEP 1—carbon activation: 10 grams of commercially available carbon was placed in a 250 ml beaker and 100 ml of 10% HNO₃ was added gently to the beaker. The mixture was stirred for 24 h at temperature of 125° C. After the reaction the mixture was added to 1000 ml of water. The solid was filtrated and wash until neutral pH conditions.

STEP 2—thermal treatment: the carbon particles were heated to 400° C. before use.

STEP 3—catalyst preparation: 100 mg of palladium nitrate were added to a beaker. 600 ml of water were added gently, followed by addition of 1 g of the activated carbon from STEP 2. The mixture was stirred for 60 min. To a second beaker were added 100 ml of water with 1 gram of potassium formate. Then the second solution was gently added to the first. Stirring continued for another 24 h. The product was filtered, washed and dried in an oven at 80° C., under air.

### Preparation 5

The carbon particles were heated to 400° C. before use. The rest is the same as explained in Preparation 1.

### Preparation 6

Preparation 1 was repeated, with a refreshment treatment (with 1% by weight hydrochloric acid) before the first catalyst use.

1. A continuous process for releasing hydrogen using the dehydrogenation reaction of the formate-bicarbonate cycle, comprising continuously feeding an aqueous solution of formate and a heterogeneous catalyst to a dehydrogenation reactor to form bicarbonate and hydrogen, directing the hydrogen for use as a fuel hydrogen, removing a flowable effluent continuously from the dehydrogenation reactor and directing the effluent into a product tank, discharging a material from the product tank and separating the catalyst from the material, washing and refreshing the catalyst and returning the refreshed catalyst to the dehydrogenation reactor, wherein bicarbonate is collected in a solid form from the product tank.

2. A process according to claim 1, wherein the catalyst consists of a catalytically-active transition metal on solid support particles, wherein the diameter of the solid support particles is less than 100 m.

3. A process according to claim 2, wherein the heterogeneous catalyst is Pd or Pt on carbon, wherein the diameter of the carbon particles is from 4 to 40 m.

4. A process according to claim 1, wherein a sieve is mounted in the product tank, partitioning the product tank into a lower section and an upper section, wherein the flowable effluent from the dehydrogenation reactor is fed to the lower section of the product tank, such that bicarbonate particles settle at the bottom of the product tank, and catalyst particles float and accumulate at the upper section of the product tank.

5. A process according to claim 4, wherein the material is discharged from the upper section of the product tank, consisting of formate solution with catalyst particles, and is fed to a separation and washing unit, in which the catalyst particles are separated from the formate solution and washed.

6. A process according to claim 5, wherein the separation and washing are performed off-line in a batch mode.

7. A process according to claim 5, wherein the separated catalyst particles are washed in the separation and washing unit by a washing solution selected from the group consisting of water, an aqueous acidic solution and an aqueous oxidizer solution.

8. A process according to claim 1, wherein the catalyst is washed by an acidic aqueous stream at a temperature above 30° C.

9. A process according to claim 1, wherein the washed catalyst particles are refreshed by drying and oxidation, performed sequentially or simultaneously.

10. A process according to claim 9, wherein the washed catalyst particles are dried and oxidized simultaneously by the action of an air stream to obtain the refreshed catalyst, which is returned to the dehydrogenation reaction.

11. A process according to claim 1, wherein the aqueous formate solution comprises potassium formate at concentration equal to or not less than 7M.

12. A process according to claim 1, wherein the dehydrogenation reaction is carried out in the presence of an alkaline agent selected from the group consisting of alkali hydroxide and alkali carbonate.

13. A process according to claim 12, wherein the dehydrogenation reaction is carried out with aqueous potassium formate at a concentration equal to or not less than 7M, in the presence of potassium carbonate at concentration of not less than 0.5 M.

14. A continuous process for storing hydrogen using the hydrogenation reaction of the formate-bicarbonate cycle, comprising continuously feeding an aqueous slurry of bicarbonate, hydrogen and a heterogeneous catalyst to a hydrogenation reactor having a sieve mounted in proximity to the reactor outlet to prevent bicarbonate particles from leaving the reactor, removing an effluent continuously from the outlet of the hydrogenation reactor and directing to a separator, wherein the effluent is in a form of a suspension comprising dissolved formate and suspended catalyst particles and residual solubilized bicarbonate, separating the effluent into an aqueous formate and a solid catalyst, wherein the separation is downstream to the hydrogenation reactor and upstream to a product tank, directing the aqueous formate to the product tank, washing and refreshing the catalyst in a washing tank, and returning the refreshed catalyst to the hydrogenation reactor continuously.

15. A process according to claim 1, wherein the hydrogen storage or release rate is controlled by adjusting the amount of catalyst supplied to the hydrogenation or dehydrogenation reactor, respectively.

16. A process for storing and releasing hydrogen using the formate-bicarbonate cycle, wherein the process comprises:
A) hydrogenation reaction producing an aqueous formate solution from bicarbonate and hydrogen in the presence of heterogeneous catalyst according to claim 14, and
B) dehydrogenation reaction decomposing the aqueous formate solution of A) to form bicarbonate and hydrogen gas in the presence of a heterogeneous catalyst,
and supplying the bicarbonate to the hydrogenation reaction of step A),
wherein the reactions are performed in a cyclic manner with catalyst separation and refreshment.

17. An apparatus for continuous production of hydrogen by dehydrogenation of aqueous formate solution, comprising:
a first storage tank, in which an aqueous formate solution is held, connected by a feed line to a dehydrogenation reactor, with a heat exchanger optionally positioned along said feed line;
a catalyst feeder to supply dry granular or powdered material to the dehydrogenation reactor, e.g., a screw conveyor hooper;
the dehydrogenation reactor, having a first outlet equipped with a gas discharge line to withdraw hydrogen gas evolving in the reactor and deliver the hydrogen to pressure cylinder or a fuel cell, and a second outlet equipped with a liquid discharge line to direct flowable effluent from the dehydrogenation reactor to a product tank;
the product tank, which is partitioned by sieve into to a lower section and an upper section, with the liquid discharge line from the dehydrogenation reactor entering the lower section of said product tank,
a separation and washing unit, which is supplied alternately by appropriate arrangement of valves either from the product tank, wherein the upper section of the product tank is connected by a discharge line to the separation and washing unit, or from a washing solution feed line, such that the separation and washing unit alternates between a separation mode, during which it is supplied by an effluent pumped through the discharge line from the product tank, and a washing mode, during which it is supplied by the washing solution;
wherein the separation and washing unit is provided with a return line to direct liquid phase consisting of formate solution collected during separation to the dehydrogenation reactor, and with a catalyst recycle line connected to a drying and oxidation unit, to supply refreshed catalyst the catalyst feeder or to spent catalyst to a storage tank.

18. An apparatus according to claim 17, wherein the drying and oxidation unit is fed by an air line to dry, oxidize and push the catalyst particles to the catalyst feeder.

19. An apparatus according to claim 17, further comprising a nitrogen line.

20. An apparatus for continuous storage of hydrogen by reacting aqueous bicarbonate slurry with hydrogen to form formate, comprising:
a first storage tank, in which bicarbonate slurry is held, connected by a feed line to a mixing unit;
a catalyst feeder to supply dry granular or powdered material to the mixing unit, e.g., a screw conveyor hooper;
a mixing unit, provided with an agitator to produce an aqueous slurry of bicarbonate and catalyst particles and with a discharge line to supply said suspension to a first hydrogenation reaction;
a first hydrogenation reactor and optionally a second hydrogenation reactor, arranged in series, wherein the discharge line of the mixing unit is connected to an inlet of the first hydrogenation reactor and wherein each hydrogenation reactor has a gas inlet connected to hydrogen feed line to introduce hydrogen gas to each hydrogenation reactor; and wherein the first hydrogenation reactor or the second hydrogenation reactor, as appropriate, discharges to a solid/liquid separation unit, wherein the first hydrogenation reactor has a sieve mounted in proximity to the reactor outlet to prevent bicarbonate particles from leaving the reactor;
A product tank, connected to the solid/liquid separation unit, to receive liquid stream therefrom consisting of aqueous formate;
A washing tank, connected to the solid/liquid separation unit, to receive the solid catalyst particles collected in the solid/liquid separation unit; wherein the washing tank is connected by a catalyst recycle line to a drying and oxidation unit, to supply refreshed catalyst the catalyst feeder or a spent catalyst to a recycle tank.

21. An apparatus according to claim 20, wherein the drying and oxidation unit is fed by an air line to dry, oxidize and push the catalyst particles to the catalyst feeder.

22. An apparatus according to claim 20, further comprising a nitrogen line, to supply nitrogen stream to the washing tank.

23. A method of distributing hydrogen on-demand from a production site to customers, comprising:
hydrogenation reaction producing an aqueous formate solution from bicarbonate and hydrogen in the presence of heterogeneous catalyst, wherein the hydrogenation reaction is run in a continuous mode of operation with on-line catalyst refreshment and recycling;
transporting the formate, either in an aqueous or dry form, to a hydrogen distribution site;
dehydrogenation reaction decomposing an aqueous formate solution to form bicarbonate and hydrogen gas on-demand in the presence of a heterogeneous catalyst wherein the hydrogenation reaction is run in a continuous mode of operation with off-line catalyst refreshment and recycling.
